(19) United States
(12) Patent Application Publication
(10) Pub. No.: US 2013/0101305 A1
(43) Pub. Date: Apr. 25, 2013

(54) IMAGE FORMING APPARATUS, IMAGE FORMING METHOD, AND FIXING DEVICE

(71) Applicants: KABUSHIKI KAISHA TOSHIBA, Tokyo (JP); TOSHIBA KABUSHIKI KAISHA, Tokyo (JP)

(72) Inventor: Hiroshi Katakura, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/649,382

(22) Filed: Oct. 11, 2012

Related U.S. Application Data
(60) Provisional application No. 61/549,331, filed on Oct. 20, 2011.

(51) Int. Cl. G03G 15/20

(52) U.S. Cl. 399/69

(57) ABSTRACT

According to one embodiment, an image forming apparatus includes an image forming unit which forms a toner image on a surface of a medium, a fixing device which includes a heating member that heats the surface of the medium and a pressing member that comes in press-contact with the heating member through the medium to heat the back side of the medium, and a control unit which controls the temperature of a surface of the heating member on the side in contact with the medium to a temperature lower than the temperature of a surface of the pressing member on the side in contact with the medium.

### CROSS-REFERENCE TO RELATED APPLICATIONS

This application is based upon and claims the benefit of U.S. Provisional Application No. 61/549,331, filed on Oct. 20, 2011; the entire contents of which are incorporated herein by reference.

### FIELD

Embodiments described herein relate generally to an image forming apparatus, an image forming method, and a fixing device.

### BACKGROUND

In recent years, the development of energy saving techniques for environmental protection is being advanced. In an image forming apparatus such as an MFP (multifunction peripheral), a formed image is printed on a medium such as a paper. A lot of energy is consumed in a fixing process in this image forming process because a medium is heated, and therefore, various studies are conducted for reducing the energy consumption of a fixing device.

Further, with the increase in consciousness about environmental issues such as preservation of forest resources to be used as a paper raw material and reduction in CO₂ emission, in the image forming apparatus, the use of back side of a used paper, duplex printing, the use of a recycled paper, and so on are widely performed. In addition, as a method capable of using a paper repeatedly, a method in which an image forming material (for example, a toner) on a paper is mechanically or chemically peeled off, and a method in which a decolorable toner which is decolored by heat, light, a chemical or the like is used for printing are known. Such a decolorable toner achieves preservation of forest resources and reduction in CO₂ emission by alternately repeating printing and erasing so that a paper is used a plurality of times.

It is necessary to heat a medium to a fixable temperature or higher for fixing an image onto the medium. On the other hand, when an image is fixed onto a medium using a decolorable toner, it is necessary to control the fixing temperature to a temperature not higher than a temperature at which the toner is erased (decoloring temperature). Therefore, when the decolorable toner is used, it is necessary to control the fixing temperature more accurately.

Accordingly, there are needs for an image forming apparatus, an image forming method, and a fixing device, capable of stably forming an image using a decolorable toner while reducing the energy consumption of a fixing device.

### BRIEF DESCRIPTION OF THE DRAWINGS

FIG. 1 is an exemplary perspective view showing an outline shape of an image forming apparatus according to a first embodiment.

FIG. 2 is an exemplary structural view showing an image forming unit according to a first embodiment.

FIG. 3 is an exemplary structural view showing a fixing device according to a first embodiment.

FIG. 4 is an exemplary view schematically showing an internal temperature distribution of a medium and a toner in a fixing nip according to a first embodiment.

FIG. 5 is an exemplary view schematically showing an internal temperature distribution of the medium and the toner in the fixing nip according to a first embodiment.

FIG. 6 is an exemplary view schematically showing an internal temperature distribution of the medium and the toner in the fixing nip according to a first embodiment.

FIG. 7 is an exemplary block diagram showing a structure of a control system according to a first embodiment.

FIG. 8 is an exemplary external view of a control panel according to a first embodiment.

FIG. 9 is an exemplary flowchart showing a procedure for controlling the temperature of a fixing device according to a first embodiment.

FIG. 10 is an exemplary view schematically showing an internal temperature distribution of a medium and a toner in a fixing nip of an image forming apparatus according to a second embodiment.

FIG. 11 is an exemplary view schematically showing an internal temperature distribution of the medium and the toner in the fixing nip according to a second embodiment.

FIG. 12 is an exemplary view schematically showing an internal temperature distribution of the medium and the toner in the fixing nip according to a second embodiment.

FIG. 13 is an exemplary view for illustrating a range, in which fixing is achieved and a color is developed, defined by the temperature of a fixing belt and the temperature of a pressing roller according to a second embodiment.

FIG. 14 is an exemplary flowchart showing a procedure for controlling the temperature of a fixing device according to a second embodiment.

FIG. 15 is an exemplary structural view showing a fixing device of an image forming apparatus according to a third embodiment.

### DETAILED DESCRIPTION

In general, according to one embodiment, an image forming apparatus includes: an image forming unit which forms a toner image on a surface of a medium; a fixing device which includes a heating member that heats the surface of the medium and a pressing member that comes in press-contact with the heating member through the medium to heat the back side of the medium; and a control unit which controls the temperature of a surface of the heating member on the side in contact with the medium to a temperature lower than the temperature of a surface of the pressing member on the side in contact with the medium.

Hereinafter, embodiments will be described.

### First Embodiment

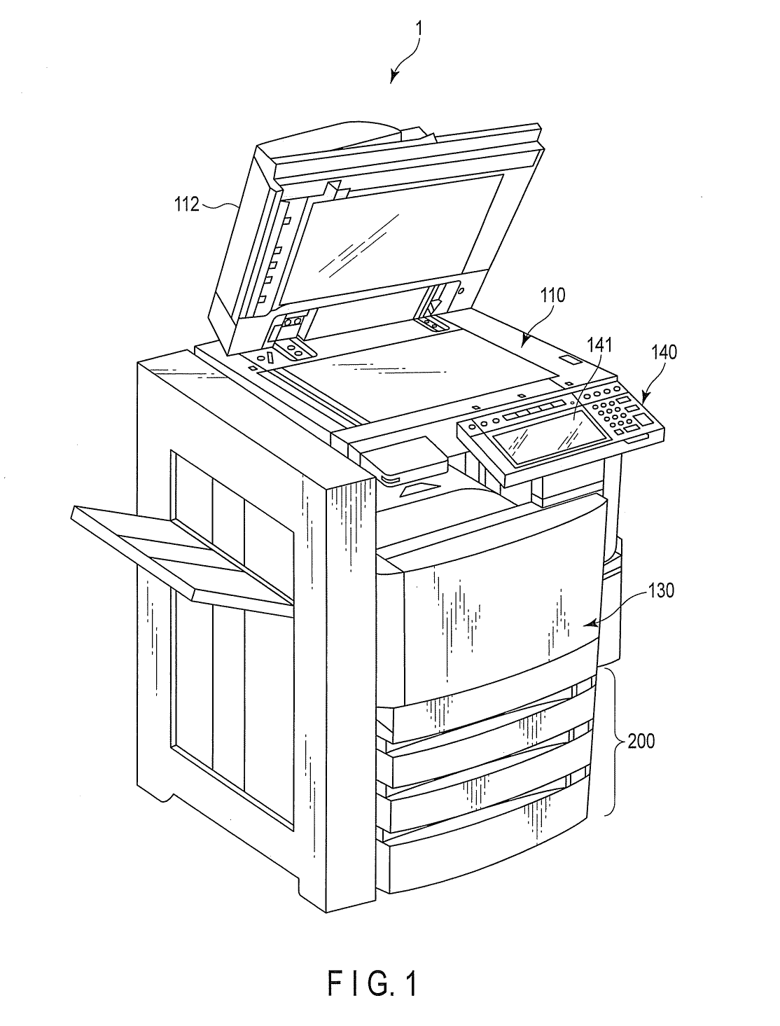

FIG. 1 is an exemplary perspective view showing an outline shape of an image forming apparatus according to a first embodiment.

An image forming apparatus 1 includes a printing unit 130, a paper tray 200, a scanning unit 110, an auto document feeder 112, and a control panel 140.

The printing unit 130 outputs image information as, for example, an output image which is called a hard copy or printout. The paper tray 200 supplies an output medium which is a sheet of paper of an arbitrary size used for outputting an image to the printing unit 130. The scanning unit 110 captures image information as image data from an original document. The auto document feeder 112 sends the original document after completion of the reading to a discharge position from a read position, and guides a subsequent original document to the read position. The control panel 140 is an instruction input unit for instructing the operation of the image forming apparatus 1 such as start of image formation in the printing unit 130 or start of reading of the image information of the original document by the scanning unit 110. The control panel 140 includes a display unit 141 for inputting an instruction and displaying information for an operator.

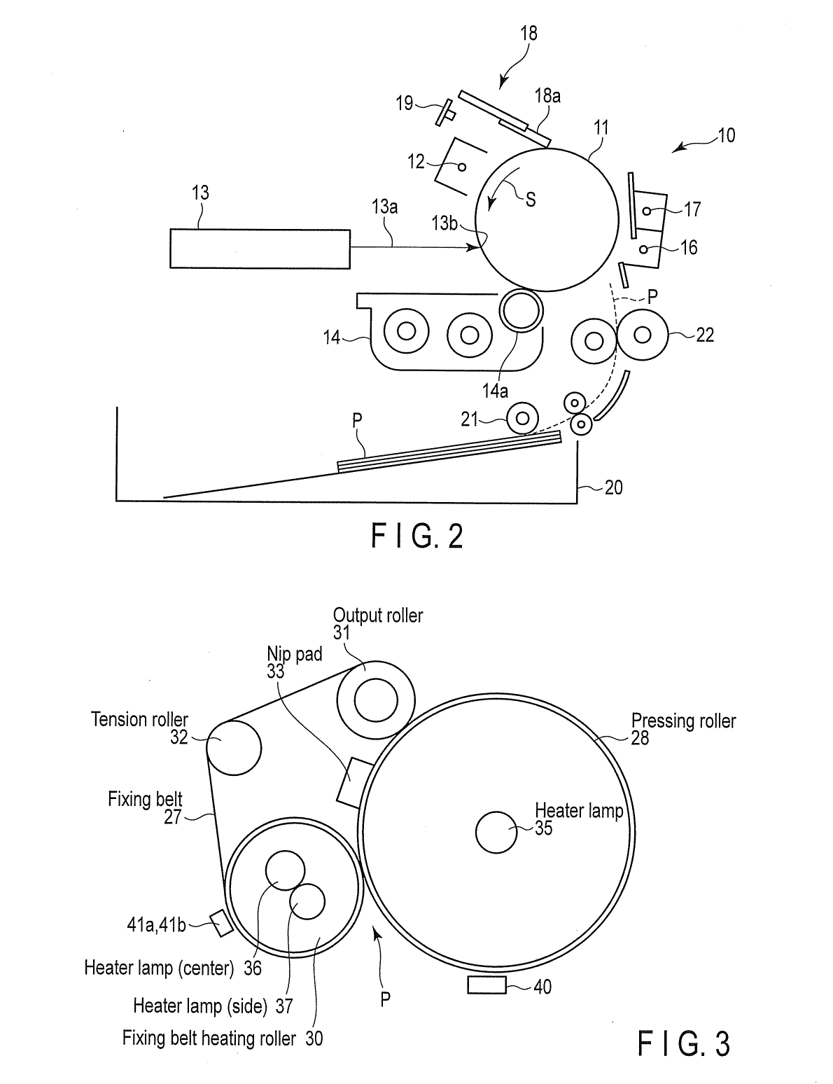

FIG. 2 is an exemplary structural view showing an image forming unit of the image forming apparatus according to the first embodiment.

A photoconductive drum 11 of an image forming unit 10 includes an organic photoconductor (OPC) on a surface of a supporting member with a diameter of 60 mm. The photoconductive drum 11 is driven in the direction indicated by an arrow s at a peripheral speed of 215 mm/sec (first paper conveying speed). Around the photoconductive drum 11, a charger 12, a laser exposure device 13, a developing device 14, a transfer charger 16, a peeling charger 17, a cleaner 18 having a cleaning blade 18a, and a discharging LED 19 are arranged.

The charger 12 uniformly charges the photoconductive drum 11 to −750 V sequentially as the photoconductive drum 11 rotates. The laser exposure device 13 irradiates the charged photoconductive drum 11 at an irradiation position 13b with a laser light 13a according to image information.

A paper P which is a recording medium is taken out by a paper feeding roller 21 from a paper feed cassette device 20. In synchronization with the formation of a toner image on the photoconductive drum 11, the paper P is conveyed by a resist roller 22 to a position of the transfer charger 16 of the image forming unit 10. On the paper P, an unfixed toner image is formed by the image forming unit 10. The paper feed cassette device 20 can feed both unused papers and reused papers.

FIG. 3 is an exemplary structural view showing a fixing device of the image forming apparatus according to the first embodiment. A fixing device 26 is provided at an upper part of the image forming unit 10. The fixing device 26 heats and presses the paper P which is a recording medium to effect fixing. The fixing device 26 includes a fixing belt 27 which forms an endless track and a pressing roller 28 which is a pressing rotor and is in press-contact with the fixing belt 27.

The fixing belt 27 is reeved around a fixing belt heating roller 30, an output roller 31, and a tension roller 32, and driven by the rotation of the fixing belt heating roller 30 which is a driving member. The pressing roller 28 is in press-contact with the outside of the fixing belt 27 by a pressing mechanism (not shown). Accordingly, the pressing roller 28 is rotated by the rotation of the fixing belt 27. On the other hand, in the inside of the fixing belt 27, a nip pad 33 is provided and press-contacts the fixing belt 27 against the pressing roller 28 by a pressing mechanism (not shown). Incidentally, a sliding member for reducing friction is provided between the nip pad 33 and the fixing belt 27.

As a material of the pressing roller 28, aluminum is used, however, a solid rubber or sponge roller may be used. A release layer is coated on the surface of the roller. As a material of the fixing belt heating roller 30, aluminum is used, and a release layer is coated on the surface of the roller. The nip pad 33 is formed by bonding silicone rubber to an auxiliary plate. The output roller 31 is formed by adhering a solid rubber to the circumference of a metal core of SUS. A material of the tension roller 32 is formed by coating a PFA tube with SUS.

On the surface of the pressing roller 28 at a center portion in a longitudinal direction, a thermistor 40 is provided and detects the surface temperature of the pressing roller 28. At a center portion and a side portion in a longitudinal direction of the fixing belt heating roller 30, thermistors 41a and 41b are provided, respectively, through the fixing belt 27 and measure the surface temperature of the fixing belt 27. Incidentally, the positions of the thermistors are not limited to the above configuration, and the thermistors may be provided at arbitrarily positions of the pressing roller 28 and the fixing belt 27. For example, a configuration in which one thermistor is provided on the fixing belt side and two thermistors are provided on the pressing roller side may be adopted.

In the inside of the pressing roller 28, one heater lamp 35 using a halogen lamp is provided as a heating source employing a heater lamp system. Also in the inside of the fixing belt heating roller 30, two heater lamps 36 and 37, each using a halogen lamp, are provided. The configuration in which two heater lamps 36 and 37 are provided for the fixing belt heating roller 30 indicates that the heating temperature, i.e., light distribution varies depending on the position in a longitudinal direction of the roller. Meanwhile, the configuration in which one heater lamp 35 is provided for the pressing roller 28 indicates that with respect to the light distribution, the light is distributed in all directions, i.e., the heating temperature is made uniform.

In the fixing device 26 shown in FIG. 3, since a nip is formed by the fixing belt 27 and the pressing roller 28, there is an advantage that a large nip can be formed. In this embodiment, the medium P is transported to the fixing belt heating roller 30, the nip pad 33, and the output roller 31 in this order while being press-contacted by the pressing roller 28 and the fixing belt 27. Accordingly, if the total amount of heat required for fixing to be given to the medium P is constant, the press-contact time can be prolonged, and therefore, it becomes possible to decrease the temperature of the pressing roller 28 and the fixing belt 27.

Next, a method for reducing heating energy to be used in the fixing device 26 will be described.

Specifically, a lowest fixing temperature was compared under the respective conditions that a relationship between a fixing belt temperature Tb and a pressing roller temperature Tp was set to as follows: Case 1: Tp=Tb−10° C., Case 2: Tp=Tb, and Case 3: Tp=Tb+10° C. Here, the lowest fixing temperature is defined as a temperature at which the lowest temperature of a toner layer reached a toner melting temperature Tm.

Incidentally, the dimensions (diameters) of the respective parts constituting the fixing device 26 are as follows: pressing roller: φ 50 mm, fixing belt heating roller: φ 25 mm, output roller: φ 14 mm, and tension roller: φ 10 mm.

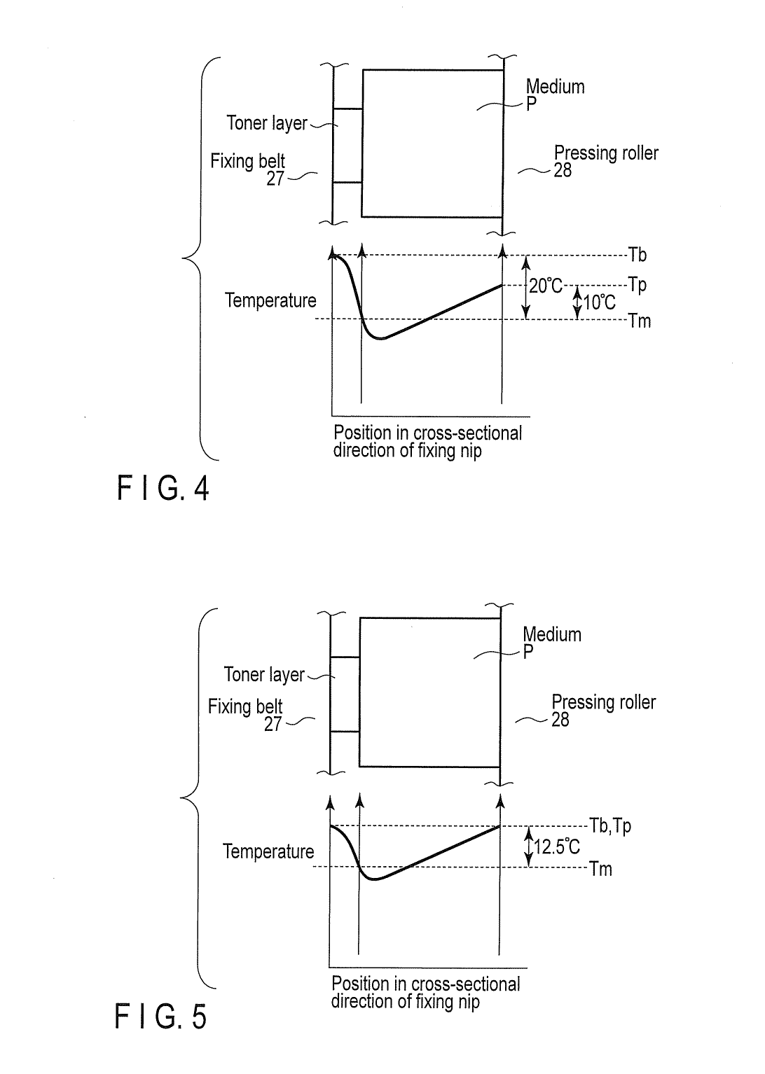

FIG. 4 is an exemplary view schematically showing an internal temperature distribution (Case 1) of a medium and a toner in the fixing nip of the image forming apparatus according to the first embodiment.

The drawing in the upper part of FIG. 4 is a transverse sectional view showing a state in which the medium P having a toner layer is heated and press-contacted by the fixing belt 27 and the pressing roller 28. The drawing in the lower part of FIG. 4 is a longitudinal sectional view showing the internal temperature distribution of the medium and the toner in the fixing nip.

Under the condition of Case 1, that is, under the condition that the pressing roller temperature Tp=the fixing belt temperature Tb−10° C., the temperature of the boundary surface between the toner layer and the medium P reached the toner melting temperature Tm when the pressing roller temperature Tp=the toner melting temperature Tm+10° C., and the fixing belt temperature Tb=the toner melting temperature Tm+20° C. It is found that under the condition of Case 1, since the medium temperature is low, the toner temperature in a contact portion between the medium P and the toner is not increased, and the overall temperature is high.

FIG. 5 is an exemplary view schematically showing an internal temperature distribution (Case 2) of the medium and the toner in the fixing nip of the image forming apparatus according to the first embodiment.

The drawing in the upper part of FIG. 5 is a transverse sectional view showing a state in which the medium P having a toner layer is heated and press-contacted by the fixing belt 27 and the pressing roller 28. The drawing in the lower part of FIG. 5 is a longitudinal sectional view showing the internal temperature distribution of the medium and the toner in the fixing nip.

An increase in temperature of the medium P was not yet sufficient under the condition of Case 2, that is, under the condition that the pressing roller temperature Tp=the fixing belt temperature Tb, and the temperature of the boundary surface between the toner layer and the medium P reached the toner melting temperature Tm when the pressing roller temperature Tp=the toner melting temperature Tm+12.5° C., and the fixing belt temperature Tb=the toner melting temperature Tm+12.5° C.

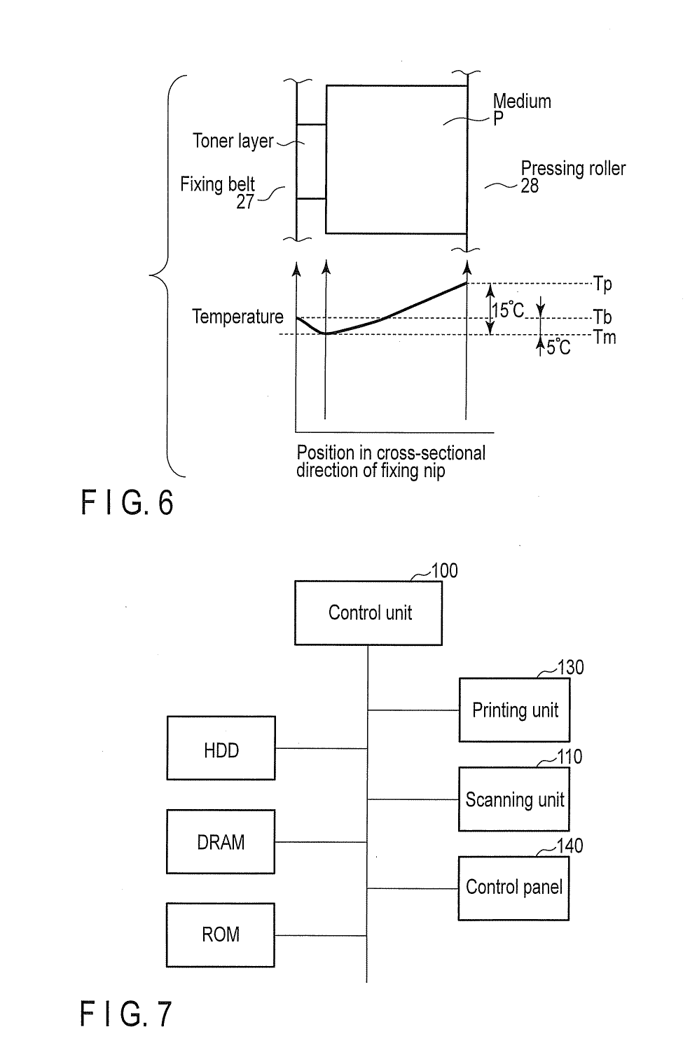

FIG. 6 is an exemplary view schematically showing an internal temperature distribution (Case 3) of the medium and the toner in the fixing nip of the image forming apparatus according to the first embodiment.

The drawing in the upper part of FIG. 6 is a transverse sectional view showing a state in which the medium P having a toner layer is heated and press-contacted by the fixing belt 27 and the pressing roller 28. The drawing in the lower part of FIG. 6 is a longitudinal sectional view showing the internal temperature distribution of the medium and the toner in the fixing nip.

Since the paper was sufficiently warmed under the condition of Case 3, that is, under the condition that the pressing roller temperature Tp=the fixing belt temperature Tb+10° C., the temperature of the boundary surface between the toner layer and the medium P reached the toner melting temperature Tm when the pressing roller temperature Tp=the toner melting temperature Tm+15° C., and the fixing belt temperature Tb=the toner melting temperature Tm+5° C.

From these results, it was found that by adopting the condition of Case 3, that is, the condition capable of setting the temperature of the fixing belt 27 which has a high heat capacity to a temperature lower than the temperature of the pressing roller 28, the energy consumption of the entire fixing device 26 can be reduced.

Incidentally, the “melting temperature” described above is a calculated value unlike the physical properties of the toner.

That is, the melting temperature was determined by calculating the temperature of the toner layer by thermal simulation from “surface temperatures of the fixing members” which give a fixing ratio represented by the formula (1) of 75% (which is a value evaluated as OK for fixability). In other words, what are actually measured are the temperatures of the fixing members, and the melting temperature of the toner is a calculated value.

Fixing ratio=(image density after rubbing)/(image density before rubbing)×100 Formula (1)

Here, the fixing ratio defined by the formula (1) corresponds to a residual ratio obtained by testing a copy having a toner image formed thereon using a fastness tester.

Next, an embodiment of an image forming apparatus for achieving the above temperature control will be described.

FIG. 7 is an exemplary block diagram showing a structure of a control system of the image forming apparatus 1 according to the first embodiment.

The image forming apparatus 1 further includes a control unit 100, a ROM, a DRAM, and an internal storage device (HDD) along with the above-described printing unit 130, scanning unit 110, and control panel 140. All of these units are connected to each other through a system bus.

The control unit 100 controls each of the units, which are connected to each other through the system bus. The ROM stores a variety of control programs which are necessary when the image forming apparatus 1 is operated. In the ROM, each program for controlling the temperature of the fixing device 26, which will be described later, is stored. The execution of each program is controlled by the control unit 100. The DRAM is a buffer memory which temporarily stores data generated when executing each program.

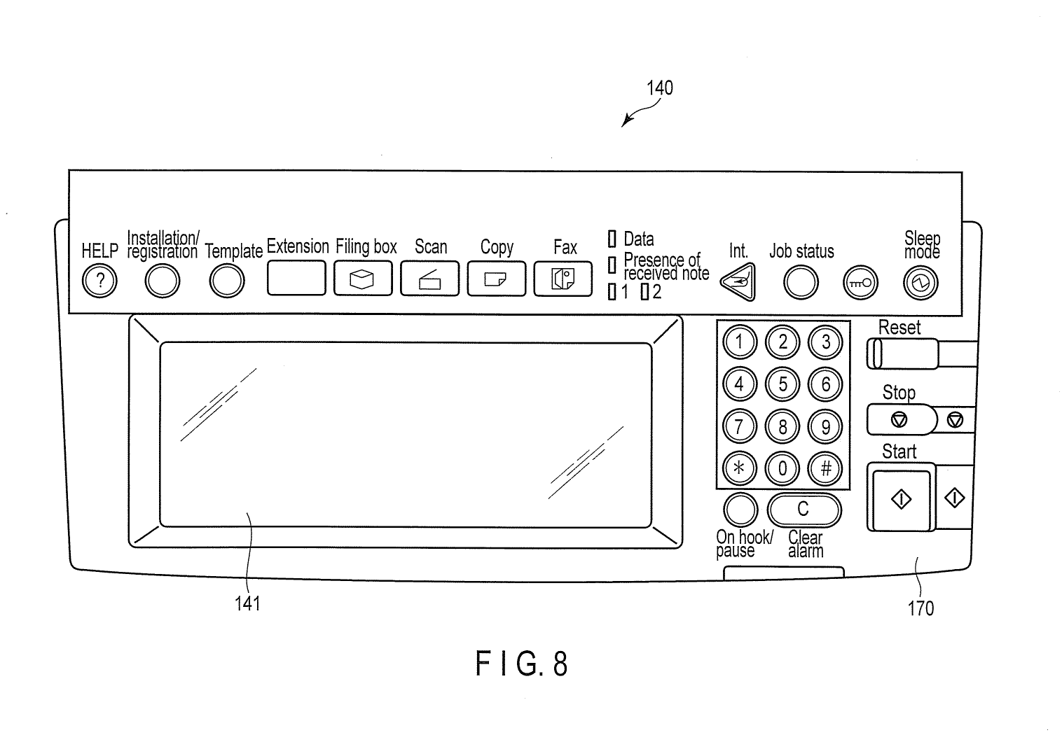

FIG. 8 is an exemplary external view of the control panel 140 provided for the image forming apparatus 1 according to the first embodiment. The control panel 140 includes the display unit 141 and an operation unit 170. The display unit 141 is constituted by a touch panel and displays a state of the image forming apparatus 1, a procedure for operation, and a variety of instructions for a user. The operation unit 170 is provided with a variety of operation buttons including a start button to operate the image forming apparatus 1.

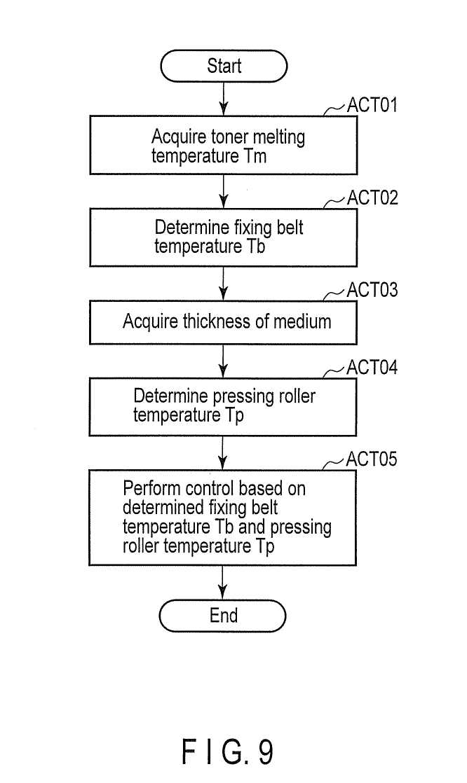

FIG. 9 is an exemplary flowchart showing a procedure for controlling the temperature of the fixing device 26 of the image forming apparatus 1 according to the first embodiment. The acts shown in FIG. 9 are performed by the control unit 100 in cooperation with the respective units of the image forming apparatus 1.

When the act of the fixing device 26 is started, in Act 01, the control unit 100 acquires the melting temperature Tm of the toner to be used. Here, as the melting temperature Tm of the toner, a value directly input by a user from the control panel 140 may be used, and also, a value may be determined using a separately acquired table on the basis of the type of toner to be used.

In Act 02, the control unit 100 determines the fixing belt temperature Tb according to the formula (2).

Fixing belt temperature Tb=Toner melting temperature Tm+α Formula (2)

Here, α is a predetermined value and may be determined according to, for example, an operation mode of the image forming apparatus 1 such as an energy saving mode or a normal mode.

In Act 03, the control unit 100 acquires the thickness of the medium P. Here, as the thickness of the medium P, a value directly input by a user from the control panel 140 may be used, and also, a value measured by a thickness sensor provided for the image forming apparatus 1 may be used. Alternatively, a characteristic value associated with the thickness may be used. For example, the weight of the medium P may be used in place of the thickness of the medium P.

In Act 04, the control unit 100 determines the pressing roller temperature Tp according to the formula (3).

Pressing roller temperature Tp=Fixing belt temperature Tb+β Formula (3)

Here, β can be determined using a table from the thickness of the medium P.

In Act 05, the control unit 100 controls the temperature of the fixing device 26 using the acquired fixing belt temperature Tb and pressing roller temperature Tp.

By using the image forming apparatus 1 according to the first embodiment as described above, the energy consumption of the fixing device 26 can be reduced.

### Second Embodiment

A second embodiment is different from the first embodiment in that the operation of the fixing device 26 is controlled using a decolorable toner. Therefore, the same units as those in the first embodiment are denoted by the same reference numerals, and a detailed description thereof is omitted.

The decolorable toner in the second embodiment is a toner which appears to be erased on a white paper by chemically reacting coloring materials contained therein with each other at a decoloring temperature Td or higher to change the color to white turbid. However, the decolorable toner is not limited to this configuration, and a toner, the color of which is changed to colorless, or a toner, the color of which is changed to a less noticeable color when performing reprinting, may be used.

The decolorable toner to be used in the second embodiment will be described.

### (1) Preparation of Dispersion of Colored Particles C1 to be Used in Decolorable Toner

1 Part of 3-(2-ethoxy-4-diethylaminophenyl)-3-(1-ethyl-2-methylindol-3-yl)-4-azaphthalide as a leuco dye, 5 parts of 2,2-bis(4-hydroxyphenyl)hexafluoropropane as a color-developing agent, and 50 parts of a diester compound of pimelic acid and 2-(4-benzyloxyphenyl)ethanol as a decoloring agent were dissolved by heating. Further, 20 parts of an aromatic polyvalent isocyanate prepolymer and 40 parts of ethyl acetate as encapsulating agents were mixed with the above-prepared solution, and the resulting solution was poured into 250 parts of an aqueous solution of 8% polyvinyl alcohol, and the resulting mixture was emulsified and dispersed. After stirring of the dispersion was continued at 90° C. for about 1 hour, 2 parts of a water-soluble aliphatic modified amine as a reaction agent was added thereto, and the stirring of the dispersion was further continued for about 3 hours while maintaining the temperature of the liquid at 90° C., whereby colorless capsule particles were obtained. Further, the resulting dispersion of the capsule particles was placed in a freezer to develop a color, whereby a dispersion of blue colored particles C1 was obtained.

The diameter of the colored particles C1 was measured using SALD-7000 manufactured by Shimadzu Corporation and found to be 2 μm. Further, a completely decoloring temperature Th was 79° C. and a completely coloring temperature Tc was −10° C.

### (2) Preparation of Dispersion of Toner Component Particles Containing Binder Resin

Dispersion of toner component particles R1 (mechanical emulsification method by mechanical shearing)

94 Parts by weight of a polyester resin (glass transition temperature: 45° C., softening point: 100° C.) as a binder resin, 5 parts by weight of rice wax as a release agent, and 1 part by weight of TN-105 manufactured by Hodogaya Chemical Co., Ltd. as a charge control agent were uniformly mixed by a dry-type mixer. Then, the resulting mixture was melt-kneaded at 80° C. by a twin-screw kneader PCM-45 manufactured by Ikegai Co., Ltd. The thus obtained toner composition was pulverized to a size of 2 mm-mesh pass by a pin mill, and thereafter further pulverized to a size of an average particle diameter of 50 μm by a bantam mill.

Then, 0.9 parts by weight of sodium dodecylbenzene sulfonate as a surfactant, 0.45 parts by weight of dimethylaminoethanol as a pH adjusting agent, and 68.65 parts by weight of ion exchanged water were mixed, and 30 parts by weight of the above-prepared pulverized toner composition was dispersed in the resulting aqueous solution, followed by vacuum defoaming, whereby a dispersion liquid was obtained.

Subsequently, by using NANO 3000 (manufactured by Beryu Co., Ltd.) provided with a 12 m-long high-pressure pipe for heat exchange immersed in an oil bath as a heating unit, a high-pressure pipe including connected nozzles having a diameter of 0.13 μm and 0.28 μm, respectively, as a pressurizing unit, a medium-pressure pipe including connected cells having a pore diameter of 0.4, 1.0, 0.75, 1.5, and 1.0 μm, respectively, as a depressurizing unit, and a 12 m-long heat exchange pipe capable of cooling with tap water as a cooling unit, the obtained dispersion liquid was subjected to pulverization treatment at 180° C. and 150 MPa. After the pressure was reduced while maintaining the temperature at 180° C., the dispersion liquid was cooled to 30° C., whereby a dispersion of toner component particles R1 was obtained.

The diameter of the thus obtained particles was measured using SALD-7000 manufactured by Shimadzu Corporation and found to be 0.5 μm.

### (3) Examples of Decolorable Toner

1.7 Parts by weight of the dispersion of colored particles C1, 15 parts by weight of the dispersion of toner component particles R1, and 83 parts by weight of ion exchanged water were mixed, and while stirring the resulting mixture at 6500 rpm in a homogenizer (manufactured by IKA Japan K.K.), 5 parts by weight of an aqueous solution of 5% aluminum sulfate was added thereto. Then, the temperature of the resulting mixture was increased to 40° C. while stirring the mixture at 800 rpm in a 1-L stirring vessel provided with a paddle blade. After the mixture was left at 40° C. for 1 hour, 10 parts by weight of an aqueous solution of 10% sodium polycarboxylate was added thereto, and the resulting mixture was heated to 68° C. and left as such for 1 hour, followed by cooling, whereby blue toner dispersion liquid was obtained.

Subsequently, the thus obtained toner dispersion liquid was subjected to washing by repeating filtration and washing with ion exchanged water until the electrical conductivity of the filtrate was decreased to 50 μS/cm. Thereafter, the toner particles were dried using a vacuum dryer until the water content was decreased to 1.0% by weight or less, whereby dry particles were obtained.

After the drying, 2 parts by weight of hydrophobic silica and 0.5 parts by weight of titanium oxide were attached as additives to the surfaces of the toner particles, whereby a decolorable toner was obtained. The particle diameter of the thus obtained toner was measured using Multisizer 3 manufactured by Beckman Coulter, Inc., and it was found that 50% volume average diameter Dv was 9.8 μm.

Next, a method for reducing heating energy used in the fixing device 26 according to the second embodiment will be described.

In the same manner as in the first embodiment, a lowest fixing temperature and a temperature at which the toner is erased (decoloring temperature) were compared under the respective conditions that the relationship between the fixing belt temperature Tb and the pressing roller temperature Tp was set to as follows: Case 1: Tp=Tb−10° C., Case 2: Tp=Tb, and Case 3: Tp=Tb+10° C. Here, the lowest fixing temperature is a temperature at which the lowest temperature of a toner layer reached the melting temperature Tm of a toner. Further, the decoloring temperature is a temperature at which a part of a toner layer reached the chemical reaction initiation temperature Td of the coloring materials. Incidentally, the dimensions (diameters) of the respective parts constituting the fixing device 26 are the same as those in the first embodiment, and therefore, a detailed description thereof is omitted.

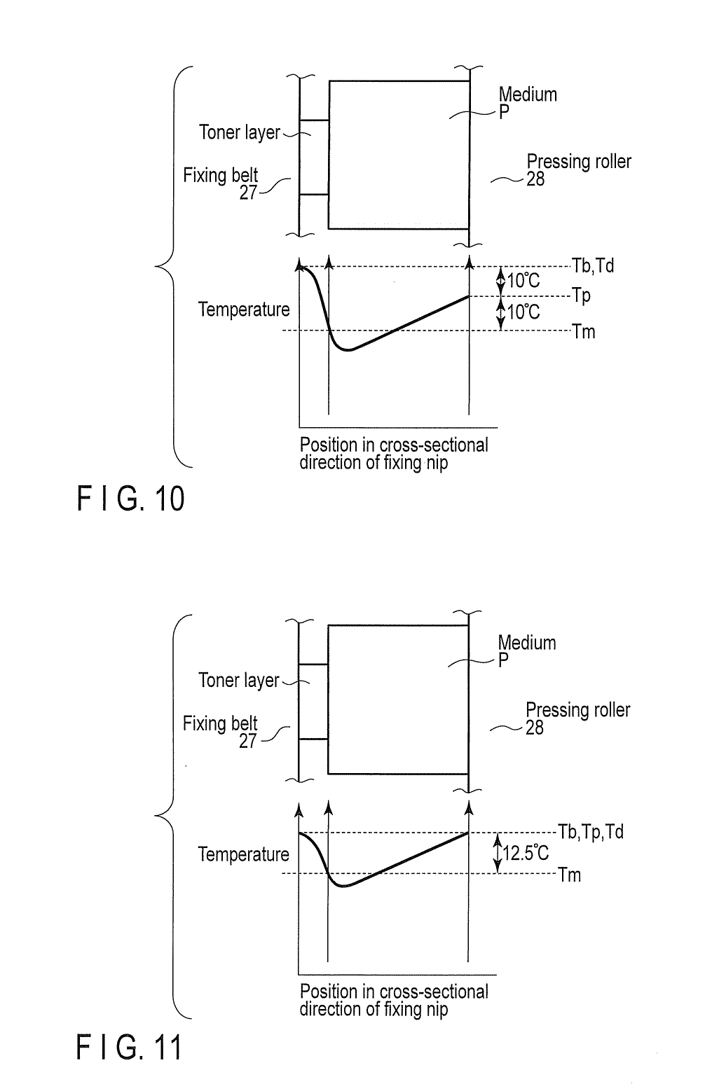

FIG. 10 is an exemplary view schematically showing an internal temperature distribution (Case 1) of a medium and a toner in the fixing nip of the image forming apparatus according to the second embodiment.

The drawing in the upper part of FIG. 10 is a transverse sectional view showing a state in which the medium P having a toner layer is heated and press-contacted by the fixing belt 27 and the pressing roller 28. The drawing in the lower part of FIG. 10 is a longitudinal sectional view showing the internal temperature distribution of the medium and the toner in the fixing nip.

Under the condition of Case 1, that is, under the condition that the pressing roller temperature Tp=the fixing belt temperature Tb−10° C., the temperature of the boundary surface between the toner layer and the medium P reached the toner melting temperature Tm when the pressing roller temperature Tp=the toner melting temperature Tm+10° C., and the fixing belt temperature Tb=the toner melting temperature Tm+20° C. Further, the condition capable of setting the temperature of the toner to a temperature lower than the decoloring temperature Td is as follows: the fixing belt temperature Tb<the decoloring temperature Td.

Accordingly, a temperature Tt of the boundary surface between the toner layer and the medium P is within a range of from Tm (lowest) to Td−20° C. (highest). That is, in Case 1, the width of temperature range in which fixing can be achieved and also a color is developed is as follows: Δ1=(Td−20)−Tm° C.=(Td−Tm)−20° C.

FIG. 11 is an exemplary view schematically showing an internal temperature distribution (Case 2) of the medium and the toner in the fixing nip of the image forming apparatus according to the second embodiment.

The drawing in the upper part of FIG. 11 is a transverse sectional view showing a state in which the medium P having a toner layer is heated and press-contacted by the fixing belt 27 and the pressing roller 28. The drawing in the lower part of FIG. 11 is a longitudinal sectional view showing the internal temperature distribution of the medium and the toner in the fixing nip.

An increase in temperature of the medium P was not yet sufficient under the condition of Case 2, that is, under the condition that the pressing roller temperature Tp=the fixing belt temperature Tb, and the temperature of the boundary surface between the toner layer and the medium P reached the toner melting temperature Tm when the pressing roller temperature Tp=the toner melting temperature Tm+12.5° C., and the fixing belt temperature Tb=the toner melting temperature Tm+12.5° C. Further, the condition capable of setting the temperature of the toner to a temperature lower than the decoloring temperature Td is as follows: the fixing belt temperature Tb<the decoloring temperature Td.

Accordingly, the temperature Tt of the boundary surface between the toner layer and the medium P is within a range of from Tm (lowest) to Td−12.5° C. (highest). That is, in Case 2, the width of temperature range in which fixing can be achieved and also a color is developed is as follows: Δ2=(Td−12.5)−Tm° C.=(Td−Tm)−12.5° C.

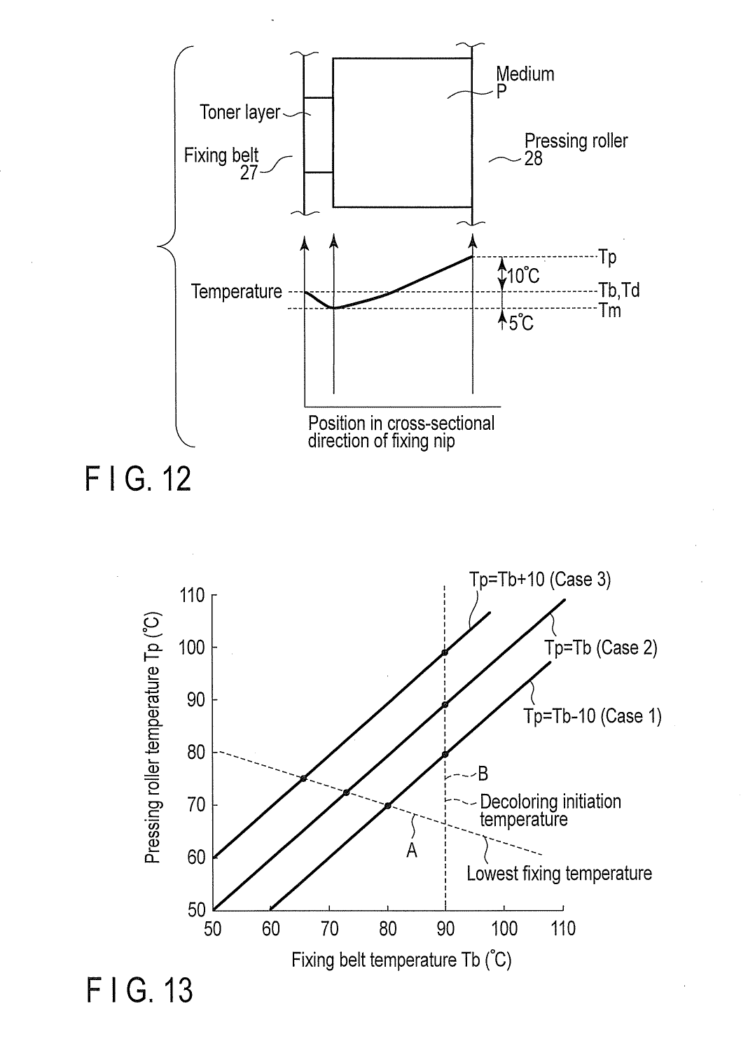

FIG. 12 is an exemplary view schematically showing an internal temperature distribution (Case 3) of the medium and the toner in the fixing nip of the image forming apparatus according to the second embodiment.

The drawing in the upper part of FIG. 12 is a transverse sectional view showing a state in which the medium P having a toner layer is heated and press-contacted by the fixing belt 27 and the pressing roller 28. The drawing in the lower part of FIG. 12 is a longitudinal sectional view showing the internal temperature distribution of the medium and the toner in the fixing nip.

Since the medium P was sufficiently warmed under the condition of Case 3, that is, under the condition that the pressing roller temperature Tp=the fixing belt temperature Tb+10° C., the temperature of the boundary surface between the toner layer and the medium P reached the toner melting temperature Tm when the pressing roller temperature Tp=the toner melting temperature Tm+15° C., and the fixing belt temperature Tb=the toner melting temperature Tm+5° C.

Accordingly, the temperature Tt of the boundary surface between the toner layer and the medium P is within a range of from Tm (lowest) to Td−5° C. (highest). That is, in Case 3, the width of temperature range in which fixing can be achieved and also a color is developed is as follows: Δ3=(Td−5)−Tm° C.=(Td−Tm)−5° C.

FIG. 13 is an exemplary view for illustrating a range, in which fixing is achieved and a color is developed, defined by the temperature of the fixing belt and the temperature of the pressing roller of the image forming apparatus according to the second embodiment.

In FIG. 13, the abscissa indicates the fixing belt temperature Tb and the ordinate indicates the pressing roller temperature Tp. In FIG. 13, three straight lines showing the respective relationships of Case 1 to Case 3 are represented by solid lines. A straight line giving a lowest fixing temperature when the toner melting temperature Tm was set to 60° C. is represented by a dotted line A. Further, a straight line giving a decoloring initiation temperature when the decoloring temperature Td was set to 90° C. is represented by a dotted line B.

In FIG. 13, a range which is on the upper side of the dotted line A and on the left side of the dotted line B is a range in which the decolorable toner can be fixed in a colored state. When the above-described width of temperature range is determined under the condition that the toner melting temperature Tm is 60° C. and the decoloring temperature Td is 90° C., Δ1=10° C., Δ2=17.5° C., and Δ3=25° C., and the width of temperature range in Case 3 is the largest.

Accordingly, from these results, by adopting the condition of Case 3, that is, the condition capable of setting the temperature of the fixing belt 27 which has a high heat capacity to a temperature lower than the temperature of the pressing roller 28, the energy consumption of the entire fixing device 26 can be reduced, and also the temperatures of the fixing belt 27 and the pressing roller 28 can be more flexibly set.

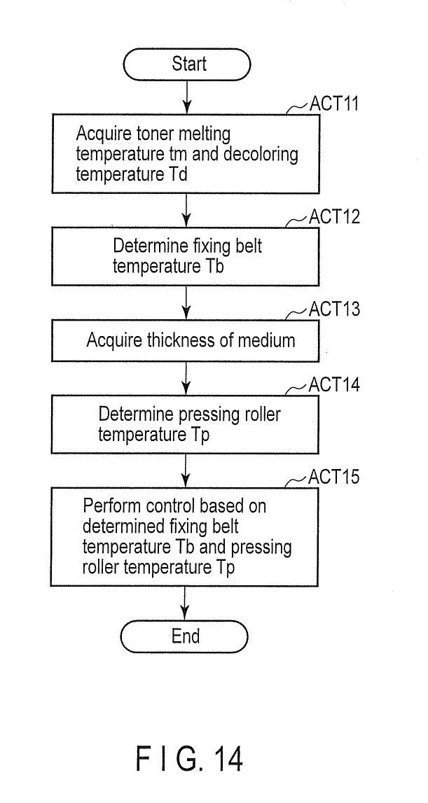

FIG. 14 is an exemplary flowchart showing a procedure for controlling the temperature of the fixing device 26 of the image forming apparatus according to the second embodiment. The acts shown in FIG. 14 are performed by the control unit 100 in cooperation with the respective units of the image forming apparatus 1.

When the act of the fixing device 26 is started, in Act 11, the control unit 100 acquires the melting temperature Tm and the decoloring temperature Td of the toner to be used. Here, as the melting temperature Tm and the decoloring temperature Td of the toner, values directly input by a user from the control panel 140 may be used, and also, values may be determined using a separately acquired table on the basis of the type of toner to be used.

In Act 12, the control unit 100 determines the fixing belt temperature Tb according to the formula (4).

Fixing belt temperature Tb=Toner melting temperature Tm+α′

with the proviso that Fixing belt temperature

Tb<Decoloring temperature Td Formula (4)

Here, α′ is a predetermined value and may be determined according to, for example, an operation mode of the image forming apparatus 1 such as an energy saving mode or a normal mode.

In Act 13, the control unit 100 acquires the thickness of the medium P. Here, as the thickness of the medium P, a value directly input by a user from the control panel 140 may be used, and also, a value measured by a thickness sensor provided for the image forming apparatus 1 may be used. Alternatively, the weight of the medium P may be used in place of the thickness of the medium P.

In Act 14, the control unit 100 determines the pressing roller temperature Tp according to the formula (5).

Pressing roller temperature Tp=Fixing belt temperature Tb+β′ Formula (5)

Here, β′ can be determined using a table from the thickness of the medium P.

In Act 15, the control unit 100 controls the temperature of the fixing device 26 using the acquired fixing belt temperature Tb and pressing roller temperature Tp.

By using the image forming apparatus 1 according to the second embodiment as described above, the energy consumption of the fixing device 26 can be reduced, and an image can be formed using the decolorable toner.

In the system using the fixing belt 27 according to the first and second embodiments, a plurality of members which are in press-contact with the pressing roller 28 are provided inside the fixing belt 27. In FIG. 3, the fixing belt heating roller 30, the nip pad 33, and the output roller 31 are provided, and by press-contacting the pressing roller 28 through the fixing belt 27 by these members, a fixing process is achieved.

Further, in the configuration shown in FIG. 3, a pressing force to be applied to the medium P is increased from the fixing belt heating roller 30 to the output roller 31, i.e., from the upstream to the downstream. For example, the fixing belt heating roller 30 applies a weak pressing force to the medium P in a narrow nip region in the upstream, the nip pad 33 applies a little strong pressing force to the medium P in a wide nip region in the midstream, and the output roller 31 applies a strong pressing force to the medium P in a narrow nip region in the downstream. By allowing these members to act as described above, fixing can be efficiently and reliably achieved, and a contribution can be made to energy saving.

### Third Embodiment

A third embodiment is different from the first and second embodiments in that the fixing device 26 is constituted using a fixing roller. Therefore, the same units as those in the first embodiment are denoted by the same reference numerals, and a detailed description thereof is omitted.

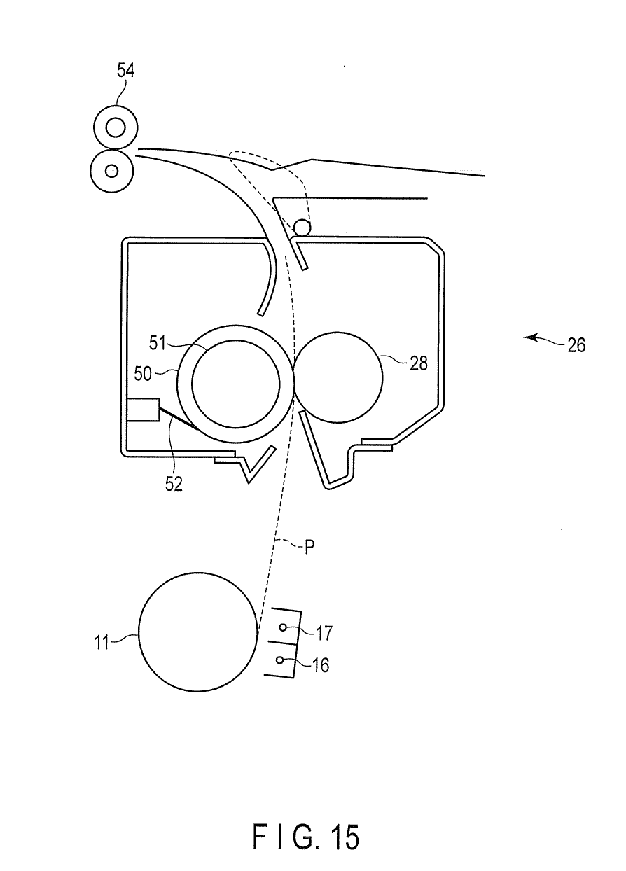

FIG. 15 is an exemplary structural view showing a fixing device of an image forming apparatus according to the third embodiment.

A fixing roller 50 is formed by coating the surface of a hollow tubular iron cylinder with PTFE (polytetrafluoroethylene). The fixing roller 50 has an IH coil (induction heating coil) 51 inside. The fixing roller 50 is directly subjected to induction heating from inside thereof. A thermistor 52 detects the surface temperature of the fixing roller 50. By an output from the thermistor 52, a current of the IH coil 51 is controlled, and the surface temperature of the fixing roller 50 is controlled to a predetermined temperature according to the control method described in the first and second embodiments.

The pressing roller 28 is configured such that an elastic layer composed of a foamable silicone sponge rubber or the like is formed on a metal shaft, and the surface thereof is coated with a PFA (copolymer of tetrafluoroethylene and a perfluoroalkylvinyl ether) tube. The pressing roller 28 has an ASKER-C hardness of about 55°. The pressing roller 28 provides a large nip of about 6 mm due to the elastic layer so that the heat capacity is reduced to achieve fixing with low energy consumption. Also the pressing roller 28 has an IH coil inside. The surface temperature of the pressing roller 28 is controlled to a predetermined temperature according to the control method described in the first and second embodiments.

A paper discharge roller 54 that discharges the paper P after fixing in a predetermined direction is provided downstream of the fixing device 26 in the conveying direction of the paper P.

After the paper P onto which the toner image is transferred is peeled from the photoconductive drum 11, the paper P is transported to the fixing device 26. The paper P is inserted between the fixing roller 50 and the pressing roller 28, and the toner image is fixed by heating and pressing. Since the fixing roller 50 and the pressing roller 28 each have a reverse crown shape, both end portions of the paper P are more reliably pulled into prior to a center portion thereof when the paper P is inserted and passed through the nip between the fixing roller 50 and the pressing roller 28. Since the pressing roller 28 has a reverse crown shape, the paper P is fixed by heating and pressing while being pulled in the direction of the end portions from the center so that wrinkles are prevented from occurring. After the toner image (including a toner image formed using a decolorable toner) is fixed in the fixing device 26, the paper P is discharged in a predetermined direction by the paper discharge roller 54.

Even when the fixing device according to the third embodiment is used, the energy consumption of the fixing device can be reduced by performing the temperature control according to the first and second embodiments.

Each of the functions explained in the above-described embodiments may be constituted using hardware and may be realized by causing a computer to read a program in which each of the functions is written using software. Each of the functions may be constituted by appropriately selecting any of the software and the hardware.

Further, each of the functions can also be realized by causing a computer to read a program stored in a recording medium (not shown). As for the recording medium in the present embodiment, a recording form thereof may be any as long as the recording medium can record the program and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image forming unit which forms a toner image on a surface of a medium;
a fixing device which includes a heating member that heats the surface of the medium and a pressing member that comes in press-contact with the heating member through the medium to heat the back side of the medium; and
a control unit which controls the temperature of a surface of the heating member on the side in contact with the medium to a temperature lower than the temperature of a surface of the pressing member on the side in contact with the medium.

2. The apparatus according to claim 1, wherein
the heating member is an endless belt which is reeved around a plurality of supporting members and driven thereby, and
the apparatus further comprises a plurality of press-contacting members which are provided inside the belt and are in press-contact with the pressing member through the belt.

3. The apparatus according to claim 2, wherein
the plurality of press-contacting members include at least one first press-contacting member in the form of a roller and at least one second press-contacting member in the form of a pad.

4. The apparatus according to claim 3, wherein
the first press-contacting member provided downstream of the second press-contacting member in the conveying direction of the medium press-contacts the pressing member more strongly than the second press-contacting member.

5. The apparatus according to claim 1, wherein
the heating member is a member in the form of a roller.

6. The apparatus according to claim 1, wherein
the control unit
determines a preset temperature of the heating member from a melting temperature of a toner,
determines a preset temperature of the pressing member from a characteristic value associated with the thickness of the medium and the preset temperature of the heating member, and
controls the temperatures of the heating member and the pressing member to the corresponding preset temperature.

7. The apparatus according to claim 6, wherein a difference in the preset temperatures between the pressing member and the heating member is increased as the thickness of the medium is increased.

8. The apparatus according to claim 1, wherein
a toner is a decolorable toner which is decolored at a decoloring temperature or higher,
the control unit
determines a preset temperature of the heating member from a melting temperature and the decoloring temperature of the toner,
determines a preset temperature of the pressing member from a characteristic value associated with the thickness of the medium and the preset temperature of the heating member, and
controls the temperatures of the heating member and the pressing member to the corresponding preset temperature, and
the preset temperature of the heating member is lower than the decoloring temperature.

9. A fixing device comprising:
a heating member which heats a surface of a medium on which a toner image is formed; and
a pressing member which comes in press-contact with the heating member through the medium to heat the back side of the medium, wherein
the temperature of a surface of the heating member on the side in contact with the medium is controlled to a temperature lower than the temperature of a surface of the pressing member on the side in contact with the medium.

10. An image forming method comprising:
forming a toner image on a surface of a medium;
heating the surface of the medium by a heating member;
heating the back side of the medium by a pressing member which comes in press-contact with the heating member through the medium; and
controlling the temperature of a surface of the heating member on the side in contact with the medium to a temperature lower than the temperature of a surface of the pressing member on the side in contact with the medium.
